(19) United States
(12) Patent Application Publication
(10) Pub. No.: US 2026/0001577 A1
(43) Pub. Date: Jan. 1, 2026

(54) INFORMATION PROCESSING DEVICE, INFORMATION PROCESSING METHOD, AND NON-TRANSITORY COMPUTER READABLE MEDIUM

(71) Applicant: NEC Corporation, Tokyo (JP)

(72) Inventors: Tatsuya FUJIMOTO, Tokyo (JP); Junichi Abe, Tokyo (JP)

(73) Assignee: NEC Corporation, Tokyo (JP)

(21) Appl. No.: 19/241,685

(22) Filed: Jun. 18, 2025

(30) Foreign Application Priority Data
Jul. 1, 2024 (JP) 2024-105937

(51) Int. Cl. B61K 9/08; G01C 15/00

(52) U.S. Cl. CPC B61K 9/08; G01C 15/002

(57) ABSTRACT

An information processing device according to the present disclosure includes: an acquisition unit that acquires first three-dimensional data of a target object measured from equipment, which is an object to be measured for displacement, and second three-dimensional data of the target object measured from the equipment in a state where no displacement occurs; and an identification unit that identifies displacement of the equipment based on a positional difference between the first three-dimensional data and the second three-dimensional data.

### INCORPORATION BY REFERENCE

This application is based upon and claims the benefit of priority from Japanese patent application No. 2024-105937, filed on Jul. 1, 2024, the disclosure of which is incorporated herein in its entirety by reference.

### TECHNICAL FIELD

The present disclosure relates to an information processing device, an information processing method, and a program.

### BACKGROUND ART

In recent years, measurement of a structure using Light Detection and Ranging (LiDAR) has been performed. For example, use of a sensing device such as LiDAR for measuring deformation of a railway has been studied. The LiDAR performs three-dimensional (3D) scanning by scanning with a laser beam. 3D data generated using LiDAR or the like is displayed on a display using a specific application or the like mounted on a computer device.

Patent Literature 1 discloses a configuration of an information processing device that identifies displacement of an object at a second time point with respect to a first time point based on results obtained by fitting each piece of three-dimensional data of the object measured at the first time point and the second time point to a predetermined model.

Patent Literature 2 discloses a configuration of a system that monitors variations of a monitoring target unit, which is a target for monitoring variations, by comparing results of measurements of the monitoring target unit and a reference point at predetermined time intervals.

Patent Literature 3 discloses measuring displacement of a Triangulated Irregular Network (TIN) model generated based on three-dimensional point cloud data of a measurement target object.
Patent Literature 1: WO 2023/127037 A1
Patent Literature 2: JP 2008-076058
Patent Literature 3: JP 2007-170821

### SUMMARY

Patent Literatures 1 to 3 disclose generation of three-dimensional data related to an object to be measured for variation or displacement. Here, in a case where the deformation of the railway is measured, it is necessary to have accuracy with which an error of a measurement result is about several tens of millimeters. Meanwhile, the accuracy of a measurement device utilizing LiDAR is generally about several centimeters. Therefore, there is a problem that it is difficult to use LiDAR to identify displacement of a structure for which accuracy of an error is required to be higher than accuracy of a measurement device using LiDAR.

An example object of the present disclosure is to provide an information processing device, a measurement system, an information processing method, and a program capable of identifying displacement with high accuracy.

An information processing device according to an example aspect of the present disclosure includes: an acquisition unit that acquires first three-dimensional data of a target object measured from equipment, which is an object to be measured for displacement, and second three-dimensional data of the target object measured from the equipment in a state where no displacement occurs; and an identification unit that identifies displacement of the equipment based on a positional difference between the first three-dimensional data and the second three-dimensional data.

An information processing method according to an example aspect of the present disclosure includes: acquiring first three-dimensional data of a target object measured from equipment, which is an object to be measured for displacement, and second three-dimensional data of the target object measured from the equipment in a state where no displacement occurs; and identifying displacement of the equipment based on a positional difference between the first three-dimensional data and the second three-dimensional data.

A program according to an example aspect of the present disclosure that causes a computer to execute acquiring first three-dimensional data of a target object measured from equipment, which is an object to be measured for displacement, and second three-dimensional data of the target object measured from the equipment in a state where no displacement occurs, and identifying displacement of the equipment based on a positional difference between the first three-dimensional data and the second three-dimensional data.

According to the present disclosure, it is possible to provide an information processing device, a measurement system, an information processing method, and a program that enable highly accurate measurement.

### BRIEF DESCRIPTION OF DRAWINGS

FIG. 1 illustrates a configuration example of an information processing device;

FIG. 2 is a diagram illustrating a flow of measurement processing executed in the information processing device;

FIG. 3 illustrates a configuration example of a measurement system;

FIG. 4 illustrates a configuration example of an information processing device;

FIG. 5 illustrates a situation in which a target object is measured from a track at different timings;

FIG. 6 illustrates a photographing direction of a target object in the measurement device;

FIG. 7 illustrates data obtained by synthesizing point cloud data of the target object at timing T1 and point cloud data of the target object at timing T2;

FIG. 8 illustrates an altitude of the track;

FIG. 9 illustrates a traveling direction, a lateral direction, and a vertical direction of a vehicle on which the measurement device is installed;

FIG. 10 illustrates an arrangement of the target object at timing T1 and timing T2 on a ZY plane;

FIG. 11 illustrates a flow of determination processing executed in the information processing device;

FIG. 12 illustrates a vehicle traveling on a track on which track displacement is occurring;

FIG. 13 illustrates a situation in which alignment displacement is occurring;

FIG. 14 illustrates a situation in which level displacement is occurring; and

FIG. 15 is a block diagram illustrating a configuration example of the information processing device.

### EXAMPLE EMBODIMENT

### First Example Embodiment

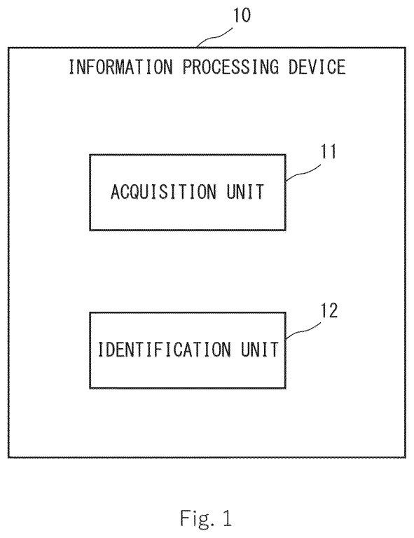

FIG. 1 illustrates a configuration example of an information processing device 10. The information processing device 10 may be a computer device that operates in a case where a processor executes a program stored in a memory. The information processing device 10 may be a server device.

The information processing device 10 includes an acquisition unit 11 and an identification unit 12. The acquisition unit 11 and the identification unit 12 may be software or modules in which processing is executed by the processor executing the program stored in the memory. Alternatively, the acquisition unit 11 and the identification unit 12 may be hardware such as circuits or chips.

The acquisition unit 11 may be used as means for acquiring data. The identification unit 12 may be used as means for identifying desired data.

The acquisition unit 11 acquires first three-dimensional data of a target object measured from equipment, which is an object to be measured for displacement, and second three-dimensional data of the target object measured from equipment in a state where no displacement occurs.

The equipment, which is an object to be measured for displacement, may be, for example, a structure or an object used for traveling of a vehicle, such as a track, a railway, or a road. The measurement from the equipment may be performed by installing a measurement device at a position in contact with the equipment, or may be performed by using a measurement device installed on a moving body moving on the equipment. The moving body may be a vehicle, a robot, a person, or the like.

The measurement device may be a sensor. Specifically, the sensor may be a distance measuring sensor that measures a distance to the target object. The distance measuring sensor may be, for example, a sensor using LiDAR. The measurement device is installed at a position in direct contact with equipment, which is an object to be measured for displacement, or at a position in indirect contact with the equipment via a moving body or the like. Based on the result measured by the measurement device, the displacement of the equipment is measured. Measuring the displacement of the equipment may be detecting or identifying the displacement of the equipment. Alternatively, the measurement device may be an image capturing apparatus that captures an image.

The equipment in a state where no displacement occurs is the same equipment as the equipment, which is an object to be measured for displacement. Further, the position on the equipment in a state where no displacement occurs and the position on the equipment, which is an object to be measured for displacement, may be substantially the same, or may be a position where a difference between the respective positions falls within a predetermined range. That is, the measurement point on the equipment in a state where no displacement occurs and the measurement point on the equipment, which is an object to be measured for displacement, may be substantially the same, or may be a position where a difference between the respective positions falls within a predetermined range.

The target object is an object provided on a road or the ground, and may be, for example, a real estate such as a building, an installation object on the ground such as a signal or a sign, or a plant. The target object may be an object of which position and appearance do not change within a predetermined period.

The three-dimensional data may be data generated according to a measurement result of the sensor. The three-dimensional data may be data that can identify the shape or appearance of the object. The three-dimensional data may be point cloud data. Alternatively, the three-dimensional data may be image data having depth information.

The point cloud data is a set of points having three-dimensional information. The three-dimensional information may be coordinates on an X axis, a Y axis, and a Z axis representing a three-dimensional space. The X axis, the Y axis, and the Z axis are orthogonal to each other. The point cloud data may be generated using a sensor. The point cloud data may be generated in a sensor using LiDAR. Alternatively, the point cloud data may be generated by matching feature points of a plurality of pieces of image data obtained by photographing the same object from a plurality of places. The generation of the point cloud data using the plurality of pieces of image data may be performed using Structure from Motion (SfM), for example. The image data may be generated by an image capturing apparatus used as a sensor.

The identification unit 12 identifies the displacement of the equipment based on the positional difference between the first three-dimensional data and the second three-dimensional data. The positional difference may be a positional difference on three-dimensional coordinates indicating the first three-dimensional data and the second three-dimensional data. Further, the positional difference may be a difference of an X coordinate component, a difference of a Y coordinate component, or a difference of a Z coordinate component in the first three-dimensional data and the second three-dimensional data. Alternatively, the positional difference may be a value obtained by combining or synthesizing differences of two or more coordinate components among the difference of the X coordinate component, the difference of the Y coordinate component, and the difference of the Z coordinate component in the first three-dimensional data and the second three-dimensional data. The three-dimensional coordinates may be, for example, coordinates in a coordinate system based on the position of the measurement device itself, or coordinates in another coordinate system. Further, the three-dimensional coordinates may be determined based on a measurement direction of the measurement device. The first three-dimensional data and the second three-dimensional data indicate positions in the same coordinate system.

In addition, the positional difference may be a distance between any point in the first three-dimensional data and a point in the second three-dimensional data corresponding to the any point in the first three-dimensional data.

A measurement device installed on equipment in a state where no displacement occurs and a measurement device installed on equipment in a state where displacement occurs have different measurement directions. That is, the measurement device installed on the equipment in a state where no displacement occurs and the measurement device installed on the equipment in a state where displacement occurs measure the target object existing in different directions. As a result, the first three-dimensional data and the second three-dimensional data are indicated as objects at different positions in one coordinate system.

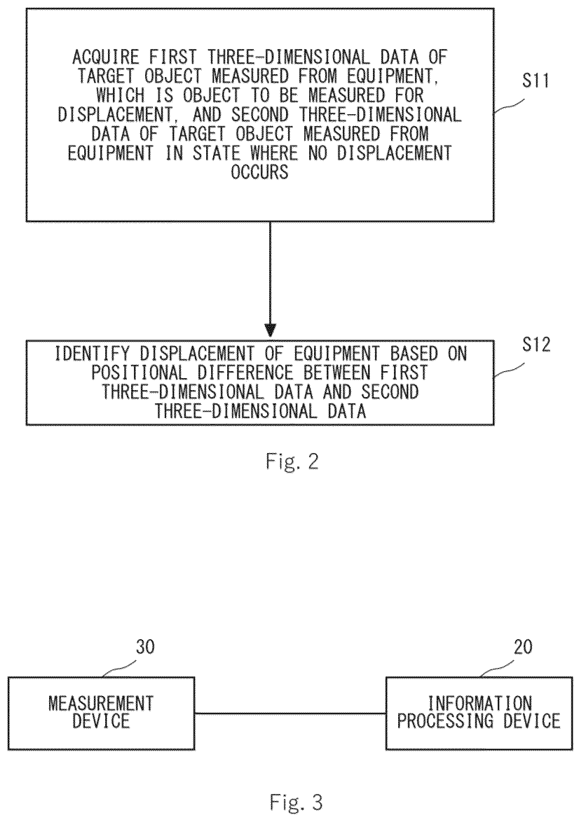

FIG. 2 is a diagram illustrating a flow of measurement processing executed in the information processing device 10. First, the acquisition unit 11 acquires first three-dimensional data of a target object measured from equipment, which is an object to be measured for displacement, and second three-dimensional data of the target object measured from equipment in a state where no displacement occurs (S11). Next, the identification unit 12 identifies the displacement of the equipment based on the positional difference between the first three-dimensional data and the second three-dimensional data (S12).

As described above, the information processing device 10 does not measure the displacement of the equipment itself, but measures the position of the target object measured from the same position before and after the displacement occurs. Furthermore, the information processing device 10 identifies the displacement of the equipment based on the positional difference of the target object. As a result, the information processing device 10 can identify the displacement of the equipment that cannot be directly measured due to the influence of the error by measuring the target object.

### Second Example Embodiment

FIG. 3 illustrates a configuration example of a measurement system. The measurement system in FIG. 3 includes an information processing device 20 and a measurement device 30. The information processing device 20 corresponds to the information processing device 10 in FIG. 1. The measurement device 30 may be a distance measuring sensor that measures a distance to an object using LiDAR. The information processing device 20 and the measurement device 30 may communicate with each other via a network. The network may be referred to as a mobile network managed by the telecommunications carrier, for example. The mobile network may be a network that provides a radio communication scheme such as so-called 4G or 5G. Alternatively, the network may be an IP network such as the Internet. The information processing device 20 and the measurement device 30 may be connected to the network via a wireless Local Area Network (LAN). Alternatively, the information processing device 20 may acquire a measurement result held by the measurement device 30 offline. For example, the information processing device 20 may acquire the measurement result in the measurement device 30 via a portable memory device or the like. Alternatively, the information processing device 20 and the measurement device 30 may be configured as an integrated device. In this case, the measurement device 30 is one component of the information processing device 20.

The measurement device 30 is attached to a vehicle traveling on a track. For example, the measurement device 30 may be attached to the vehicle to perform measurement with the traveling direction of the vehicle as the front. The direction in which the traveling direction of the vehicle is the front may be, for example, a direction substantially parallel to the traveling direction of the vehicle. The measurement device 30 may set the position at which the beam output from the measurement device 30 in the direction parallel to the traveling direction of the vehicle is reflected as the position of the center of the point cloud data.

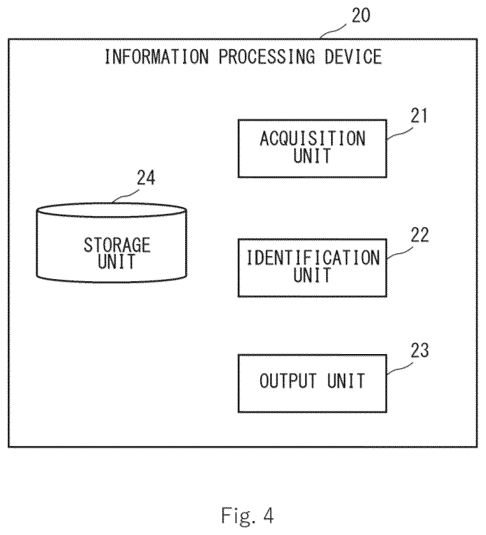

FIG. 4 illustrates a configuration example of the information processing device 20. The information processing device 20 corresponds to the information processing device 10 in FIG. 1. The information processing device 20 includes an acquisition unit 21, an identification unit 22, an output unit 23, and a storage unit 24. The acquisition unit 21 and the identification unit 22 correspond to the acquisition unit 11 and the identification unit 12 in FIG. 1. In the following description, functions and processing of the acquisition unit 21 and the identification unit 22 different from those of the acquisition unit 11 and the identification unit 12 of the information processing device 10 will be described.

The acquisition unit 21, the identification unit 22, and the output unit 23 may be software or modules in which processing is executed by the processor executing a program stored in the memory. Alternatively, the acquisition unit 21, the identification unit 22, and the output unit 23 may be hardware such as circuits or chips.

The output unit 23 may be used as means for outputting information. The storage unit 24 may be used as means for storing information. The term storing may be replaced with recording, memorizing, registering, or the like. The storage unit 24 may be, for example, a memory included in the information processing device 20. Specifically, the storage unit 24 may be a memory provided inside the information processing device 20. Alternatively, the storage unit 24 may be a memory externally attached to the information processing device 20.

The acquisition unit 21 acquires three-dimensional data from the measurement device 30. For example, the acquisition unit 21 acquires the point cloud data from the measurement device 30. For example, the measurement device 30 may execute measurement at the time at which the vehicle passes through an observation position on the track. The observation position may be determined in advance. Furthermore, a plurality of observation positions may be provided on the track. The measurement device 30 generates point cloud data regarding at least one object by executing measurement at the observation position. The acquisition unit 21 acquires point cloud data measured at different timings by the measurement device 30. That is, the acquisition unit 21 acquires a plurality of pieces of point cloud data having different measurement timings at the same observation position.

Here, the measurement device 30 is installed in a moving vehicle. Therefore, the measurement device 30 generates the point cloud data of a target object 60 while moving. As a result, since the relative position between the measurement device 30 and the target object 60 changes, the image of the target object 60 indicated by the point cloud data may be distorted. The image of the target object 60 being distorted may mean that the target object 60 becomes an extended image as a result of integrating the point cloud data generated while moving.

In such a case, the acquisition unit 21 may correct the moving amount in the traveling direction of the vehicle 40, that is, the traveling direction of the measurement device 30 using data such as an Inertial Measurement Unit (IMU), and restore the point cloud data indicating the target object 60.

The identification unit 22 identifies the displacement of the track using the point cloud data. The track displacement is also referred to as track irregularity. The track displacement may be a deformation amount of the track. The track displacement may be, for example, displacement generated in a railway. The railway may be, for example, a rail on which a railway vehicle travels. Track displacement occurs due to various factors. For example, the track displacement may occur due to the influence of natural disaster or the like, or may occur due to construction or the like around the track. Alternatively, the track displacement may occur due to aging of the rail.

The track displacement includes, for example, alignment displacement, height displacement, level displacement, gauge displacement, flatness displacement, and the like. The alignment displacement means that there is distortion in the length direction of the rail side surface. The height displacement means that there is distortion in the length direction of the top surface of the rail. The level displacement means that there is a difference in height between the left and right rails. The gauge displacement is a difference from a basic dimension of the gauge (the distance between the left and right rails). Flatness displacement is a state where “twist” with respect to the plane of the track occurs, and there is a difference between the levels of two points at a constant interval.

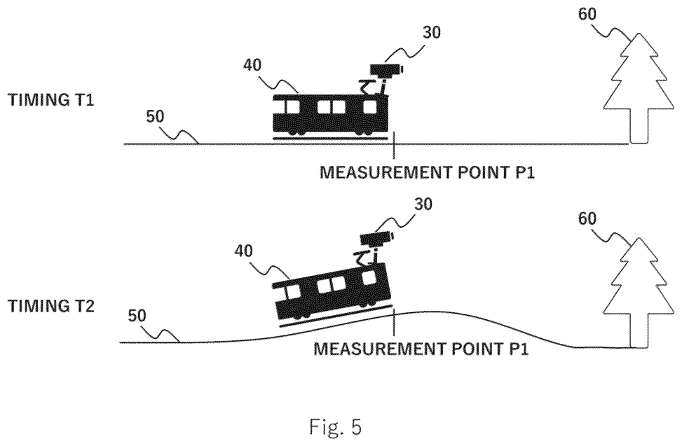

Here, a method of identifying the track displacement will be described with reference to FIG. 5. FIG. 5 illustrates a situation in which the target object is measured from the track at different timings. FIG. 5 illustrates timing T1 and timing T2 as measurement timings. Timing T2 is a timing later than timing T1. That is, the time of timing T1 is earlier than the time of timing T2. Timing T1 is a timing before track displacement occurs. Timing T2 is a timing after the track displacement occurs.

FIG. 5 illustrates that the vehicle 40 on which the measurement device 30 is installed measures the target object 60 at a measurement point P1 on the track 50 while traveling on the track 50. The measurement point may be referred to as an observation position. The vehicle 40 may be, for example, a train traveling on a railway. In FIG. 5, a tree is illustrated as the target object 60. In addition, the track 50 at timing T2 is in a state where height displacement occurs with respect to the track 50 at timing T1. Measuring the target object 60 at the measurement point P1 means generating the point cloud data of the target object 60 or acquiring the point cloud data at the measurement point P1.

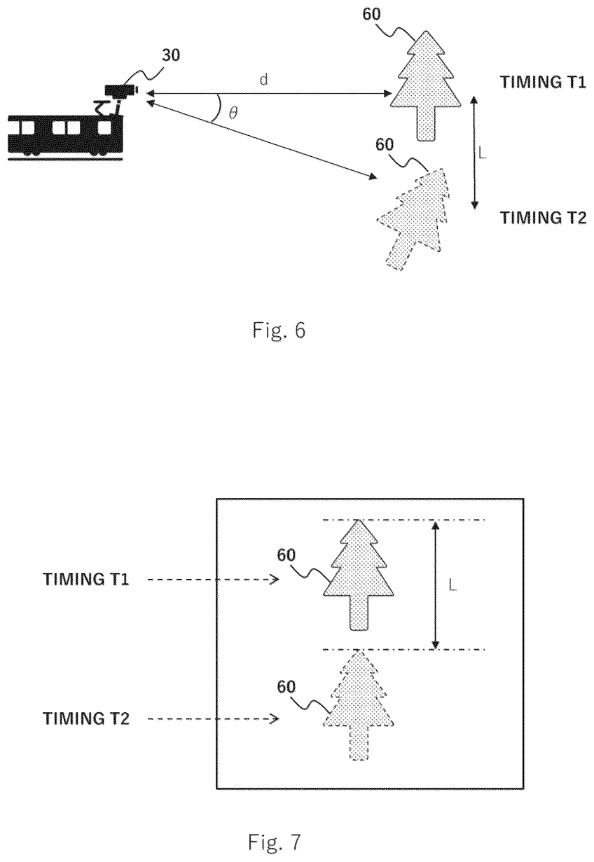

FIG. 6 illustrates a photographing direction of the target object 60 in the measurement device 30. FIG. 6 illustrates the point cloud data of the target object 60 generated by the measurement device 30 at timing T1 and the point cloud data of the target object 60 generated at timing T2.

An angle between a direction in which the measurement device 30 measures the target object 60 at the measurement point P1 at timing T1 and a direction in which the measurement device 30 measures the target object 60 at a measurement point P2 at timing T2 is defined as an angle θ. The direction in which the measurement device 30 measures the target object 60 at the measurement point P1 may be, for example, a straight line connecting the measurement device 30 and any point included in the target object 60. The any point may be, for example, a point positioned at the center of gravity of the target object 60, a point at the highest position of the tree, a point at the lowest position of the tree, or the like.

A distance between the measurement device 30 and the target object 60 at timing T1 is defined as d. Furthermore, the distance between the position of the target object 60 at timing T1 and the position of the target object 60 at timing T2 is set to L. The distance L, the distance d, and the angle θ are expressed as L=d×tanθ. Here, the distance L will be described with reference to FIG. 7.

FIG. 7 illustrates data obtained by synthesizing the point cloud data of the target object 60 at timing T1 and the point cloud data of the target object 60 at timing T2. The synthesizing may be representing the point cloud data of the target object 60 at timing T1 and the point cloud data of the target object 60 at timing T2 in the same coordinate system. Although FIG. 7 is shown as two-dimensional data for ease of description, it may be shown as three-dimensional data.

At timing T2, the measurement device 30 measures an area above the direction horizontal to the ground surface due to the influence of the height displacement occurring in the track. Therefore, the position of the target object 60 at timing T2 is positioned below the position of the target object 60 at timing T1.

Here, the position of the target object 60 is a position determined in a coordinate system defined by the measurement device 30. The coordinate system defined by the measurement device 30 is, for example, a coordinate system centered on the measurement device 30. In other words, the coordinate system defined by the measurement device 30 may be a coordinate system determined based on a specific measurement direction in the measurement device 30. Therefore, in a case where the measurement direction of the measurement device 30 changes due to the influence of the displacement of the track, even when the target object 60 is measured from the same measurement point at different timings, the respective target objects 60 exist at different positions.

In FIG. 7, the difference between the vertex of the highest position of the target object 60 at timing T1 and the vertex of the highest position of the target object 60 at timing T2 is represented as the distance L between the respective target objects 60. The distance L may be calculated using not the vertex at the highest position of the target object 60 but the vertex at the lowest position, a point positioned at the center of gravity, or the like.

After identifying the distance L and the distance d, the identification unit 22 identifies the angle θ by calculating the angle θ=arctan (L/D). The identification unit 22 identifies the angle θ at each measurement point on the track. The identification unit 22 identifies the displacement amount of the track at timing T2 using the angle θ.

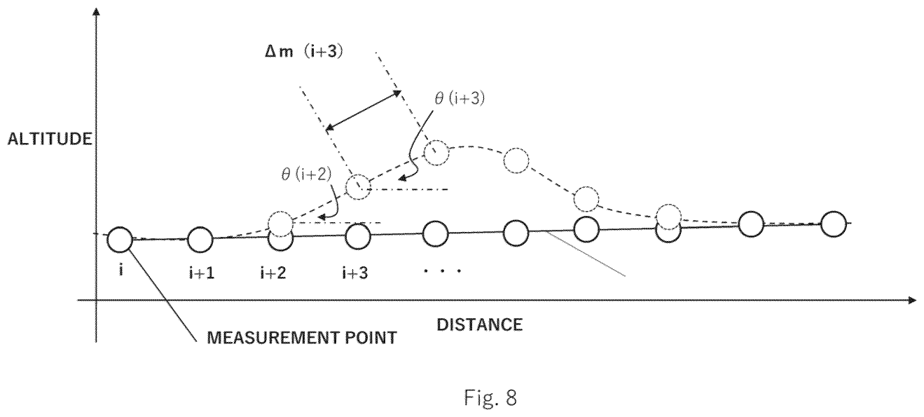

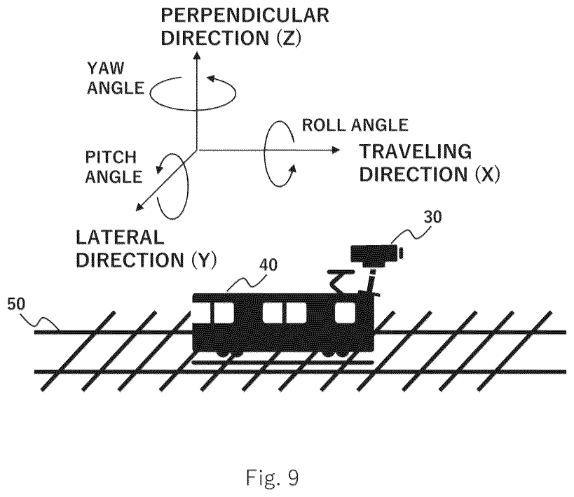

FIG. 8 illustrates the altitude of the track. A solid line in FIG. 8 indicates a track at timing T1, and a dotted line indicates a track at timing T2. A part indicated by a circle indicates a measurement point. The interval of the distance between the measurement points at timing T2 is Δm. The symbol i indicates an i-th measurement point. Δm(i+1) is a distance between the (i+1)th measurement point and the i-th measurement point. θ(i) is an angle at the i-th measurement point. The angle is a value of an angle formed by the measurement direction of the measurement device 30 at timings T1 and T2. The measurement direction may be the traveling direction of the vehicle 40 in which the measurement device 30 is installed. That is, the angle may be an angle formed by the traveling direction at the same measurement point on the track at timing T1 and timing T2.

At this time, the altitude Z of the track, which is an object to be measured, at timing T2 is expressed by the following Equation (1).

$$Z = {\sum }_{i} \{ sin {θ}_{i} \cdot Δ {l}_{i} \} + Const \qquad ( 1 )$$

In a case where the measurement data on the track is handled as a continuous value, the altitude information of the track can be obtained using the following Equation (2).

$$Z = \int sin θ ( l ) dl \qquad ( 2 )$$

The identification unit 22 may determine that an unacceptable amount of displacement occurred in a case where the altitude at timing T2, which indicates the displacement from the track at timing T1, exceeds a threshold value. In a case where it is determined that an unacceptable amount of displacement occurred, the output unit 23 outputs information indicating an abnormality. Furthermore, in a case where it is determined that an unacceptable amount of displacement did not occur, the output unit 23 may output information indicating normality. The information indicating the abnormality may be, for example, a message displayed on a display or the like, or a sound for notifying the abnormality. The threshold value may be a predetermined value at which the track displacement is considered to occur. Alternatively, the threshold value may be a value smaller than a value at which the track displacement is considered to occur. Setting the threshold value to a value smaller than a value at which the track displacement is considered to occur may be intended to detect the track displacement in a preventive manner.

In the description of FIGS. 5 to 8, the height displacement has been mainly described, but the same applies to other track displacements.

FIG. 9 illustrates the traveling direction, the lateral direction, and the vertical direction of the vehicle 40 on which the measurement device 30 is installed. The traveling direction of the vehicle 40 on the track is an X axis, the lateral direction is a Y axis, and the vertical direction is a Z axis. A rotation angle about the X axis is defined as a roll angle, a rotation angle about the Y axis is defined as a pitch angle, and a rotation angle about the Z axis is defined as a yaw angle.

The angle θ used to detect the height displacement in FIGS. 5 to 8 indicates a pitch angle. Here, in order to detect the level displacement and the flatness displacement, it is necessary to identify the angle of the roll angle. In order to detect the alignment displacement, it is necessary to identify the angle of the yaw angle.

Assuming that the angle of the yaw angle is ψ, the displacement in the X-axis direction can be calculated using the following Equation (3).

$$X = {\sum }_{i} \{ cos {ψ}_{i} \cdot cos {θ}_{i} \cdot Δ {l}_{i} \} + Const \qquad ( 3 )$$

Furthermore, the displacement in the Y-axis direction can be calculated using the following Equation (4).

$$Y = {\sum }_{i} \{ sin {ψ}_{i} \cdot cos {θ}_{i} \cdot Δ {l}_{i} \} + Const \qquad ( 4 )$$

The displacement in the Z-axis direction can be calculated using Equation (1).

For example, in a case where the displacement in the Y-axis direction exceeds a threshold value, the identification unit 22 may determine that an unacceptable amount of displacement occurred. In a case where the displacement in the Y-axis direction exceeds the threshold value, the identification unit 22 may determine that the alignment displacement occurred.

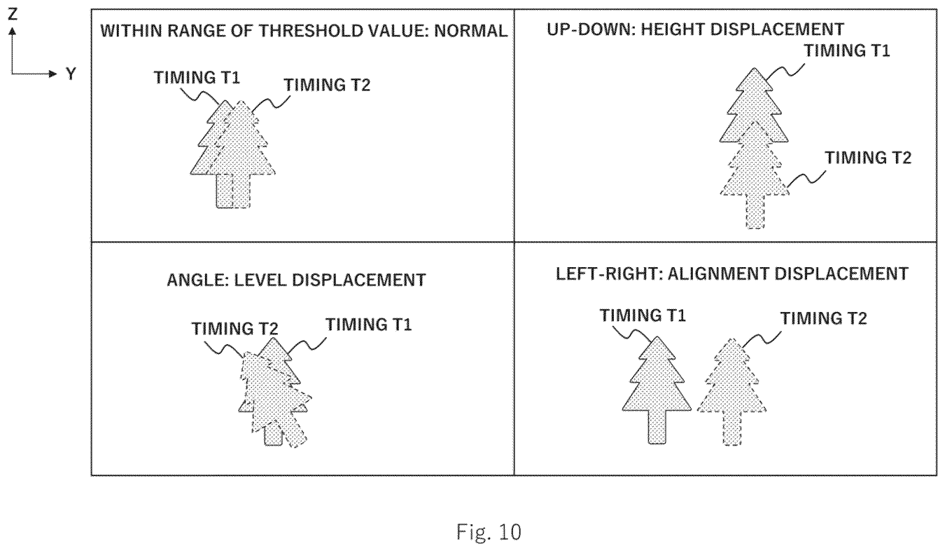

FIG. 10 illustrates the arrangement of the target object 60 at timing T1 and timing T2 on the ZY plane. The upper left part of FIG. 10 illustrates a state where an unacceptable amount of displacement did not occur in the track 50. That is, the upper left part of FIG. 10 indicates a normal state. The upper right part of FIG. 10 illustrates a state where the height displacement occurred in the track 50. The lower right part of FIG. 10 illustrates a state where the alignment displacement occurred in the track 50. The lower left part of FIG. 10 illustrates a state where the displacement of the angle of the roll angle exceeds the threshold value and the level displacement occurred.

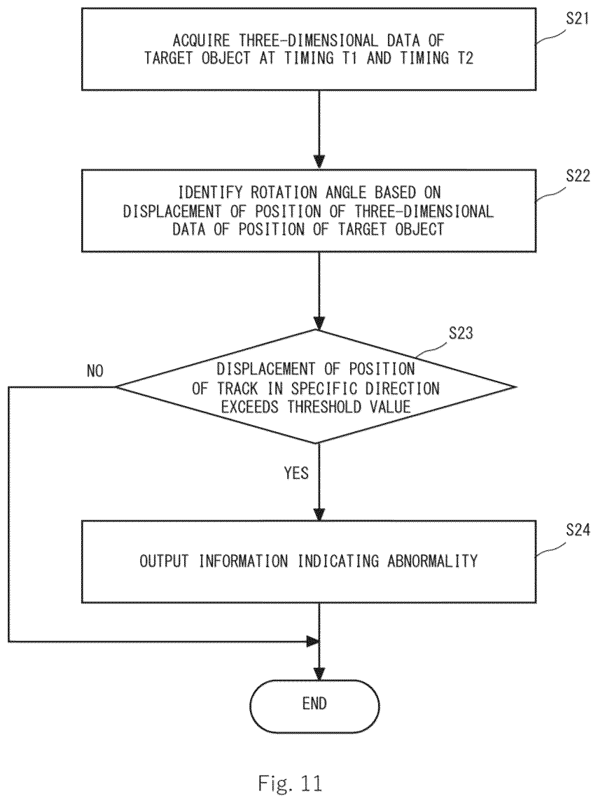

FIG. 11 illustrates a flow of determination processing executed in the information processing device 20. First, the acquisition unit 21 acquires three-dimensional data of the target object 60 at timing T1 and timing T2 (S21). Next, the identification unit 22 identifies the rotation angle based on the displacement of the position of the target object 60 at timing T2 with respect to the position of the target object 60 at timing T1 (S22).

Next, the identification unit 22 determines whether the displacement of the activation position in the specific direction exceeds the threshold value (S23). For example, the identification unit 22 identifies the displacement of the track at the position in the Y-axis direction or the Z-axis direction according to the rotation angle identified in step S22. Furthermore, the identification unit 22 may determine whether the rotation angle exceeds the threshold value. The identification unit 22 determines whether the identified displacement of the track exceeds the threshold value. Next, in a case where it is determined in step S23 that the activation displacement exceeds the threshold value, the output unit 23 outputs information indicating abnormality (S24). The output unit 23 may output a type of displacement determined according to an axis or a rotation angle at which the displacement of the track exceeds the threshold value as the abnormality information.

As described above, the information processing device 20 can identify the displacement of the track according to the displacement of the position of the target object 60 without directly measuring the track. As a result, even in a case where the measurement device does not have accuracy enough to identify the displacement, the information processing device 20 can identify the displacement of the track.

### Third Example Embodiment

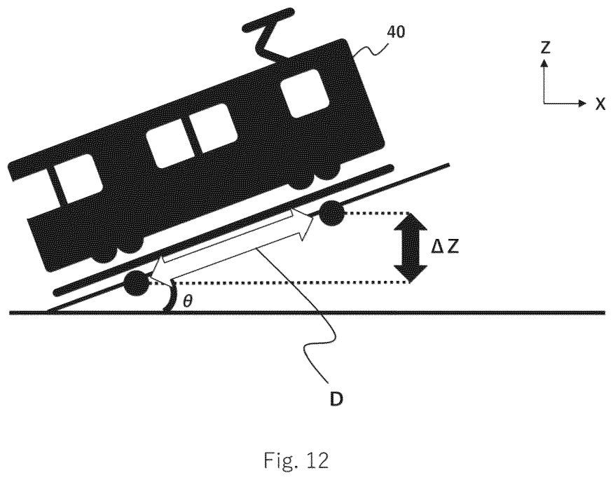

FIG. 12 illustrates the vehicle 40 traveling on the track on which track displacement is occurring. The traveling direction of the vehicle 40 after the occurrence of the track displacement is a direction of the angle θ with respect to the traveling direction of the vehicle 40 before the occurrence of the track displacement. The angle θ indicates a pitch angle. Here, a length between wheels of the vehicle, which is a contact point between the vehicle 40 and the track, is defined as a baseline length D. The baseline length D is a line used as a reference length in a case where the displacement amount of the track is used. In addition, the baseline length may be a length of the vehicle instead of the length between the wheels.

In FIG. 12, displacement amount ΔZ in the Z-axis direction is expressed by the following Equation (5).

$$Δ Z = D \cdot sin θ \qquad ( 5 )$$

In a case where the baseline length D is sufficiently long, the identification unit 22 can detect the track displacement without adding the displacement in the Z-axis direction using Equation (1) or (2). For example, in a case where the value of ΔZ is a length of the baseline length D capable of detecting a value exceeding the threshold value for detecting the height displacement, it can be said that the baseline length D is sufficiently long.

For example, in a case where ΔZ is equal to or more than 20 millimeters, it is assumed that the identification unit 22 can identify the height displacement. Here, in a case where the angle θ indicates an angular displacement of 0.5 degrees and the baseline length is 1 meter, the value of ΔZ is approximately 9 millimeters. In addition, in a case where the angle θ indicates an angular displacement of 0.5 degrees and the baseline length is 10 meters, the value of ΔZ is approximately 87 millimeters. As described above, in a case where the baseline length is 10 meters, the identification unit 22 can detect the track displacement without adding the displacement in the Z-axis direction using Equation (1) or (2).

In a case where a vehicle having a baseline length longer than a predetermined length is used, the identification unit 22 may identify the track displacement according to the value of ΔZ calculated using Equation (5). For example, in a case where the predetermined length is a predetermined angular displacement value, the predetermined length may be a length that can calculate a value of ΔZ that can identify the track displacement. For example, in a case where the value of the predetermined pitch angle θ is 0.5 degrees, the length of the baseline length at which ΔZ is a value equal to or more than 20 millimeters may be set as the predetermined length.

In FIG. 12, the identification of the height displacement has been described, but the identification of the alignment displacement and the level displacement will be described below.

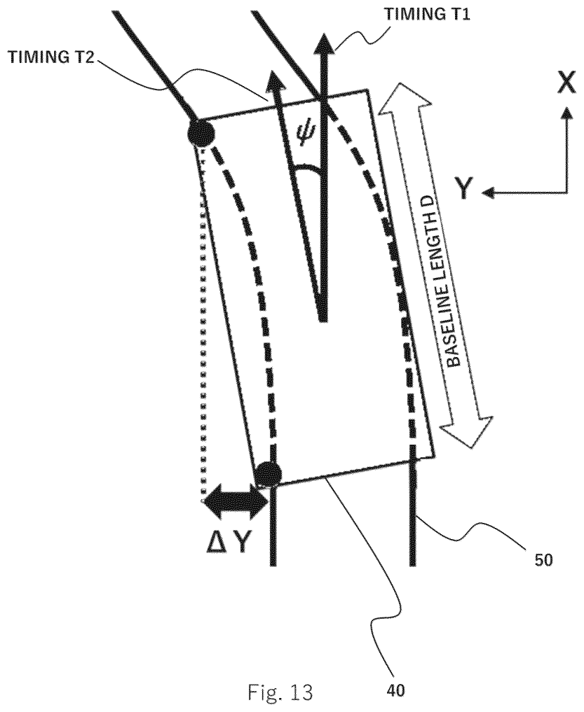

FIG. 13 illustrates a situation in which the alignment displacement is occurring. FIG. 13 illustrates a state in a case where the track is viewed from the Z-axis direction which is a direction perpendicular to the ground surface. The angle ψ of the yaw angle indicates an angle of the measurement direction of the measurement device 30 at timing T2 with respect to the measurement direction of the measurement device 30 at timing T1. In this case, ΔY, which is the displacement in the Y-axis direction, is calculated by changing the pitch angle to the angle ψ of the yaw angle in Equation (5).

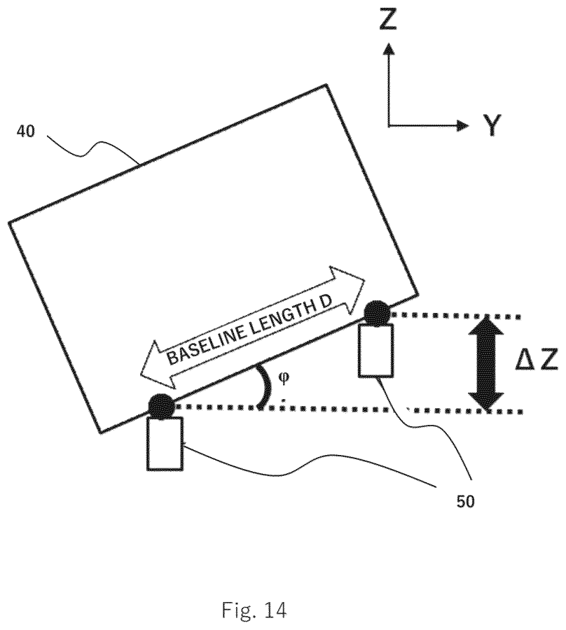

FIG. 14 illustrates a situation in which the level displacement is occurring. FIG. 14 illustrates a state in a case where viewed from the traveling direction of the track 50. The angle φ of the roll angle indicates the inclination of the vehicle caused by the difference in height between the left and right rails at timing T2. In this case, ΔZ, which is the displacement in the Z-axis direction, is calculated by changing the pitch angle to the angle φ of the roll angle in Equation (5).

As described above, in a case where the measurement device 30 is installed in a vehicle having a baseline length longer than a predetermined length, the information processing device 20 can easily identify the displacement amount of the track using Equation (5).

### Fourth Example Embodiment

In a fourth example embodiment, processing in which the identification unit 22 compares the displacement amount of the target object with the threshold value to determine whether the track displacement occurs will be described.

As illustrated in FIG. 10, the identification unit 22 may compare the displacement amount in the Z-axis direction between the target object 60 at timing T1 and the target object 60 at timing T2 displayed on the ZY plane, which is a plane perpendicular to the traveling direction with the threshold value. The displacement amount in the Z-axis direction may be, for example, a difference in a Z coordinate component between any point of the target object 60 at timing T1 and a point of the target object 60 at timing T2 corresponding to the any point. In a case where the displacement amount in the Z-axis direction is larger than the threshold value, the identification unit 22 may determine that the height displacement occurred.

Furthermore, the identification unit 22 may compare the displacement amount in the Y-axis direction between the target object 60 at timing T1 and the target object 60 at timing T2 with the threshold value. In a case where the displacement amount in the Y-axis direction is larger than the threshold value, the identification unit 22 may determine that the alignment displacement occurred.

Furthermore, the identification unit 22 may compare the rotation amount of the target object 60 at timing T2 with respect to the target object 60 at timing T1 with the threshold value. The rotation amount may be an angle formed by an axis passing through two points constituting the target object 60 at timing T1 and an axis passing through two points constituting the target object 60 at timing T2, the two points at timing T2 corresponding to the two points constituting the target object 60 at timing T1. The identification unit 22 may determine that the level displacement occurred in a case where the rotation amount is larger than the threshold value.

The threshold value to be compared with the displacement amount or the rotation amount by the identification unit 22 may be determined based on the distance between the measurement device 30 and the target object 60. As the distance between the measurement device 30 and the target object 60 increases, the displacement amount or the rotation amount of the target object 60 increases. Therefore, the threshold value may be set to a larger value as the distance between the measurement device 30 and the target object 60 becomes longer.

As described above, the identification unit 22 determines whether the track displacement occurred by comparing the displacement amount or the rotation amount of the target object 60 with the threshold value. As a result, the identification unit 22 can omit the processing of calculating the displacement amount of the track itself. As a result, the processing load on the information processing device 20 is reduced as compared with the case of executing the processing of calculating the displacement amount of the track itself.

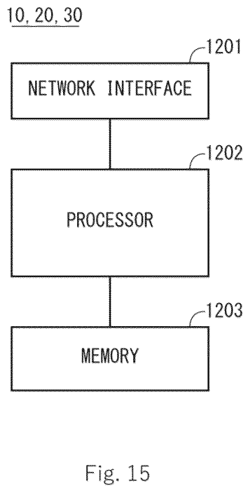

FIG. 15 is a block diagram illustrating a configuration example of the information processing device 10 and the information processing device 20 (hereinafter, referred to as the information processing device 10 and the like). Referring to FIG. 15, the information processing device 10 and the like include a network interface 1201, a processor 1202, and a memory 1203. The network interface 1201 may be used to communicate with network nodes. The network interface 1201 may include, for example, a network interface card (NIC) conforming to IEEE 802.3 series. The IEEE represents the Institute of Electrical and Electronics Engineers.

The processor 1202 executes the processing in the information processing device 10 and the like described using the flowcharts, by reading software (computer programs) from the memory 1203 and executing the software. The processor 1202 may be, for example, a microprocessor, a micro processing unit (MPU), or a central processing unit (CPU). The processor 1202 may include a plurality of processors.

The memory 1203 includes a combination of a volatile memory and a nonvolatile memory. The memory 1203 may include a storage disposed away from the processor 1202. In this case, the processor 1202 may access the memory 1203 via an input/output (I/O) interface (not illustrated). In the example in FIG. 15, the memory 1203 is used to store a software module group. The processor 1202 can execute the processing of the information processing device 10 and the like, by reading and executing these software module group from the memory 1203.

As described with reference to FIG. 15, each of the processors included in the information processing device 10 and the like executes one or a plurality of programs including a command group for causing a computer to perform the algorithm described with reference to the drawings.

In the example described above, the program includes a group of commands (or software codes) for causing a computer to execute one or more functions described in the example embodiments in a case where the program is read by the computer. The program may be stored in a non-transitory computer-readable medium or a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer-readable medium or a communication medium. By way of example, and not limitation, the transitory computer-readable medium or communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example to illustrate one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for describing illustrative example embodiments are not necessarily mandatory, and some features or steps may be omitted. The order of the steps described in any of the figures may be changed as appropriate.

Some or all of the above-described example embodiments may be described as the following Supplementary Notes, but are not limited to the following supplementary notes.

### Supplementary Note 1

An information processing device including:
an acquisition unit that acquires first three-dimensional data of a target object measured from equipment, which is an object to be measured for displacement, and second three-dimensional data of the target object measured from the equipment in a state where no displacement occurs; and
an identification unit that identifies displacement of the equipment based on a positional difference between the first three-dimensional data and the second three-dimensional data.

### Supplementary Note 2

The information processing device according to Supplementary Note 1, in which the identification unit identifies an angle of a measurement direction of a sensor for measuring the first three-dimensional data with reference to the measurement direction of the sensor for measuring the second three-dimensional data, and identifies displacement of the equipment based on the angle.

### Supplementary Note 3

The information processing device according to Supplementary Note 2, in which the displacement of the equipment is a value obtained by adding displacement amounts at a plurality of measurement points on the equipment.

### Supplementary Note 4

The information processing device according to Supplementary Note 2, in which the displacement of the equipment is identified based on the angle and a baseline length determined based on a size of a moving body on which the sensor is mounted.

### Supplementary Note 5

The information processing device according to any one of Supplementary Notes 1 to 4, in which the equipment is a track.

### Supplementary Note 6

The information processing device according to Supplementary Note 5, in which the identification unit identifies height displacement of the track based on a positional difference between the first three-dimensional data and the second three-dimensional data in an up-down direction that is a direction substantially orthogonal to a ground surface.

### Supplementary Note 7

The information processing device according to Supplementary Note 5, in which the identification unit identifies alignment displacement of the track based on a positional difference between the first three-dimensional data and the second three-dimensional data in a left-right direction that is a direction substantially parallel to a ground surface.

### Supplementary Note 8

The information processing device according to Supplementary Note 5, in which the identification unit identifies the level displacement of the track based on an angle of an inclination of the first three-dimensional data with respect to the second three-dimensional data.

### Supplementary Note 9

The information processing device according to Supplementary Note 6, in which the identification unit identifies the height displacement of the track based on a comparison result between the positional difference between the first three-dimensional data and the second three-dimensional data in the up-down direction, and a threshold value.

### Supplementary Note 10

The information processing device according to any one of Supplementary Note 5 to 9, in which the first three-dimensional data and the second three-dimensional data are measured using a sensor attached to a vehicle traveling on the track.

### Supplementary Note 11

A measurement system including:
a measurement device that measures a distance to a target object; and
an information processing device including an acquisition unit that acquires first three-dimensional data of a target object measured from equipment, which is an object to be measured for displacement, and second three-dimensional data of the target object measured from the equipment in a state where no displacement occurs, and an identification unit that identifies displacement of the equipment based on a positional difference between the first three-dimensional data and the second three-dimensional data.

### Supplementary Note 12

An information processing method including:
acquiring first three-dimensional data of a target object measured from equipment, which is an object to be measured for displacement, and second three-dimensional data of the target object measured from the equipment in a state where no displacement occurs; and
identifying displacement of the equipment based on a positional difference between the first three-dimensional data and the second three-dimensional data.

### Supplementary Note 13

A program that causes a computer to execute
acquiring first three-dimensional data of a target object measured from equipment, which is an object to be measured for displacement, and second three-dimensional data of the target object measured from the equipment in a state where no displacement occurs, and
identifying displacement of the equipment based on a positional difference between the first three-dimensional data and the second three-dimensional data.

Some or all of the elements (such as configurations and functions, for example) described in Supplementary Notes 2 to 10 dependent on Supplementary Note 1 may be dependent on Supplementary Notes 11 to 13 as well with dependent relationships similar to those of Supplementary Notes 2 to 10. Some or all of the elements described in any Supplementary Note may be applied to various types of hardware, software, recording means for recording software, systems, and methods.

1. An information processing device comprising:
at least one memory storing instructions; and
at least one processor configured to execute the instructions to:
acquire first three-dimensional data of a target object measured from equipment, which is an object to be measured for displacement, and second three-dimensional data of the target object measured from the equipment in a state where no displacement occurs; and
identify displacement of the equipment based on a positional difference between the first three-dimensional data and the second three-dimensional data.

2. The information processing device according to claim 1, wherein the at least one processor is further configured to execute the instructions to identify an angle of a measurement direction of a sensor for measuring the first three-dimensional data with reference to the measurement direction of the sensor for measuring the second three-dimensional data, and identify displacement of the equipment based on the angle.

3. The information processing device according to claim 2, wherein the displacement of the equipment is a value obtained by adding displacement amounts at a plurality of measurement points on the equipment.

4. The information processing device according to claim 2, wherein the displacement of the equipment is identified based on the angle and a baseline length determined based on a size of a moving body on which the sensor is mounted.

5. The information processing device according to claim 1, wherein the equipment is a track.

6. The information processing device according to claim 5, wherein the at least one processor is further configured to execute the instructions to identify height displacement of the track based on a positional difference between the first three-dimensional data and the second three-dimensional data in an up-down direction that is a direction substantially orthogonal to a ground surface.

7. The information processing device according to claim 5, wherein the at least one processor is further configured to execute the instructions to identify alignment displacement of the track based on a positional difference between the first three-dimensional data and the second three-dimensional data in a left-right direction that is a direction substantially parallel to a ground surface.

8. The information processing device according to claim 5, wherein the at least one processor is further configured to execute the instructions to identify the level displacement of the track based on an angle of an inclination of the first three-dimensional data with respect to the second three-dimensional data.

9. The information processing device according to claim 6, wherein the at least one processor is further configured to execute the instructions to identify the height displacement of the track based on a comparison result between the positional difference between the first three-dimensional data and the second three-dimensional data in the up-down direction, and a threshold value.

10. The information processing device according to claim 5, wherein the first three-dimensional data and the second three-dimensional data are measured using a sensor attached to a vehicle traveling on the track.

11. An information processing method comprising:
acquiring first three-dimensional data of a target object measured from equipment, which is an object to be measured for displacement, and second three-dimensional data of the target object measured from the equipment in a state where no displacement occurs; and
identifying displacement of the equipment based on a positional difference between the first three-dimensional data and the second three-dimensional data.

12. A non-transitory computer readable medium storing a program that causes a computer to execute processing comprising:
acquiring first three-dimensional data of a target object measured from equipment, which is an object to be measured for displacement, and second three-dimensional data of the target object measured from the equipment in a state where no displacement occurs, and
identifying displacement of the equipment based on a positional difference between the first three-dimensional data and the second three-dimensional data.
